(19) United States
(12) Patent Application Publication
(10) Pub. No.: US 2018/0222518 A1
(43) Pub. Date: Aug. 9, 2018

(54) CURVE AND TERRAIN RESPONSIVE STEERING SYSTEM

(71) Applicant: Peter Joseph Hill, Hilton Head Island, SC (US)

(72) Inventor: Peter Joseph Hill, Hilton Head Island, SC (US)

(21) Appl. No.: 15/888,399

(22) Filed: Feb. 5, 2018

Related U.S. Application Data
(60) Provisional application No. 62/456,222, filed on Feb. 8, 2017.

(51) Int. Cl. B62D 1/10; B60N 2/02; B60W 30/18; B62D 5/00

(52) U.S. Cl. CPC B62D 1/10; B60N 2/0232; B60W 30/18145; B60R 2021/01252; B60Y 2400/305; B60N 2002/0212; B60Y 2400/304; B62D 5/001

(57) ABSTRACT

A system and method automatically adjusts a driver's steering experience based upon driving conditions, including turns and terrain. In accordance with one embodiment, the steering wheel essentially bends into the turn and advances towards the driver, thereby providing a more natural and enjoyable driving experience. The system comprises one or more sensors disposed within the vehicle to measure g-forces. A processor in the vehicle, receiving the signals from the sensors, sends control signals to the steering wheel in response to the signals received. An electromechanical system physically moves the steering wheel relative to a driver of the vehicle in response to the control signals received from the processor. Other embodiments cause one or more seats in the vehicle to moves in response to turns, acceleration and/or deceleration (braking).

### REFERENCE TO RELATED APPLICATIONS

This Application claims priority to U.S. Provisional Patent Application Ser. No. 62/456,222, filed Feb. 8, 2017, the entire content of which is incorporated herein by reference.

### FIELD OF THE INVENTION

This invention relates generally to transportation and, more particularly, to a system and method that enhances the experience of drivers and passengers in motor vehicles and other forms of transportation.

### BACKGROUND OF THE INVENTION

In existing motor vehicles, the steering wheel and seats are fixed in position. While it is true that steering wheels can be “adjusted” to suit a particular driver, and while it is also true that seats may be adjusted for comfort, these adjustments are typically made before driving the car. Once the vehicle is in motion, the position of the steering wheel and seats remain fixed.

When a car enters an abrupt right-hand turn, the driver feels “thrown” against the door due to centrifugal force. This is caused by inertia, pressing the driver against the door. The same thing happens to a front seat passenger when the vehicle enters a left-handed curve. Experiencing these forces can be unnatural and unpleasant, particularly with sportier cars able to negotiate sharp turns.

### SUMMARY OF THE INVENTION

This invention automatically adjusts a driver's steering experience based upon driving conditions, including turns and terrain. In accordance with one embodiment, the steering wheel essentially bends into the turn and advances towards the driver, thereby providing a more natural and enjoyable driving experience.

The curve and terrain responsive steering system is adapted for use with a vehicle having a steering wheel, accelerator, and braking system. The system comprises one or more sensors disposed within the vehicle to measure g-forces. A processor in the vehicle, receiving the signals from the sensors, sends control signals to the steering wheel in response to the signals received. An electromechanical system physically moves the steering wheel relative to a driver of the vehicle in response to the control signals received from the processor.

In accordance with the preferred embodiment, the one or more sensors are operative to measure the g-forces associated with a right or left turn of the vehicle, and the electromechanical system is operative to tilt the steering wheel in the direction of the turn. In alternative embodiments the one or more sensors are operative to measure the g-forces associated with a deceleration or acceleration of the vehicle, and move the steering wheel toward or away from a driver in response to the deceleration or acceleration.

The steering wheel may be attached to a steering column that also physically moves in conjunction with the steering wheel relative to a driver of the vehicle in response to the control signals received from the processor.

The system may further include a pivoting seat within the vehicle, with the electromechanical apparatus being operative to cause the seat to tilt from side-to-side in the direction of a turn or from front-to-back in response to vehicle braking and acceleration. This aspect of the invention affect the tilting of a passenger seat as well as the driver's seat.

The processor may be in communication with, or form part of, an existing vehicle electronic control unit (ECU), and the vehicle steering system may be a fly-by-wire steering system with no direct mechanical linkage between the steering wheels and vehicle wheels. The one or more sensors may include an accelerometer, gyroscope or combinations thereof. The electromechanical system operative to physically move the steering wheel may include a motor, linear actuator, or combinations thereof.

### BRIEF DESCRIPTION OF THE DRAWINGS

FIG. 1 is a simplified, top-down drawing that shows a vehicle and steering wheel position associated with normal, straight-line driving;

FIG. 2 is a drawing that shows how a steering wheel is tilted in response to a right-handed turn;

FIG. 3A illustrates the side-to-side tilt of an integral steering wheel and steering column in accordance with the invention;

FIG. 3B illustrates the tilting of a steering wheel without tilting the steering column;

FIG. 4 is a drawing that shows how a steering wheel is tilted in response to a left-handed turn;

FIG. 5A shows a steering wheel in a “home” position;

FIG. 5B shows the steering wheel of FIG. 5A being advanced toward a driver in conjunction with an emergent braking situation;

FIG. 5C shows the steering wheel of FIG. 5A being pulled away from a driver in conjunction with a vehicle acceleration;

FIG. 6 is a block diagram illustrating major electronic subsystems associated with the invention;

FIG. 7 illustrates a seat-movement system constructed in accordance with the invention;

FIG. 8 depicts the operation of the seat-movement system of FIG. 7 in conjunction with a right-handed turn;

FIG. 9 depicts the operation of the seat-movement system of FIG. 7 in conjunction with a left-handed turn; and

FIG. 10 is a diagram that illustrates airbag considerations.

### DETAILED DESCRIPTION OF THE PREFERRED EMBODIMENTS

In broad and general terms, this invention automatically adjusts a driver's steering experience based upon driving conditions, including turns and terrain. In accordance with one embodiment, the steering wheel essentially “bends into the turn and advances towards the driver,” thereby providing a more natural and enjoyable control of the vehicle. In other embodiments, the driver's seat may also automatically adjust in concert with the steering wheel. Passenger seats may respond as well. In further embodiments, the steering wheel may advance toward or away from a driver in response to forced deceleration and acceleration, respectively.

To accomplish these goals, the invention integrates gyroscopic and/or road sensing technology into a vehicle's steering, seating and/or airbag systems. Such apparatus may be used in any type of motor vehicle, as well as boats, airplanes and military applications. The movement(s) of the steering wheel/column may be used separately from the movement(s) of the seats, or the movements may be combined for dramatic effect.

### The Steering System

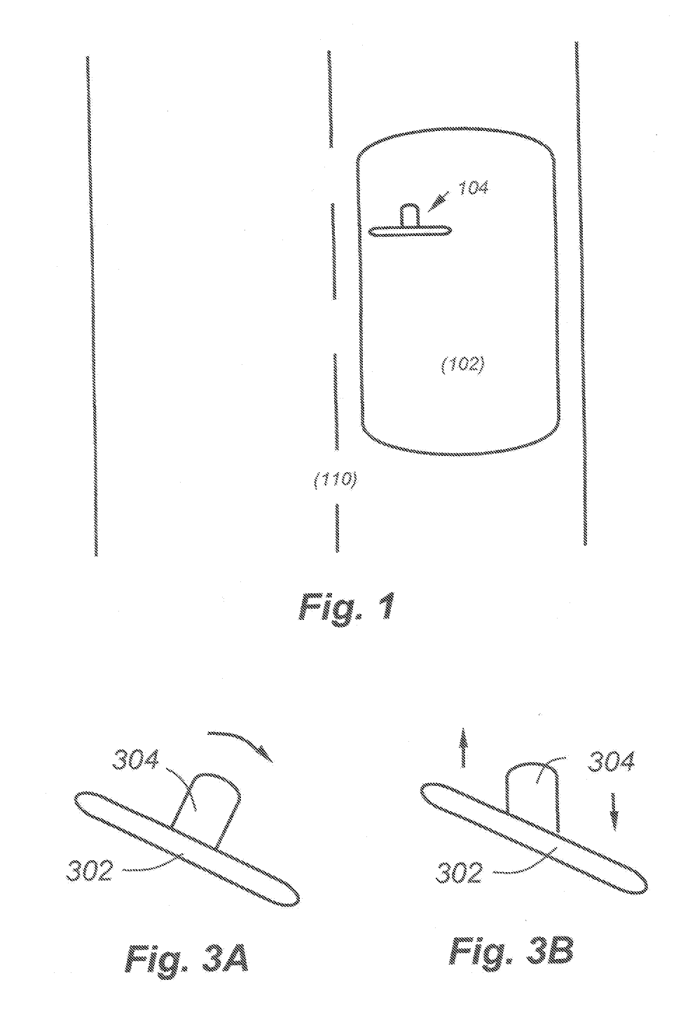

FIG. 1 represents normal straight driving. This position is called the home position. In this configuration, notwithstanding up-down tilt, the steering wheel 104 in the vehicle is generally perpendicular to the road 110.

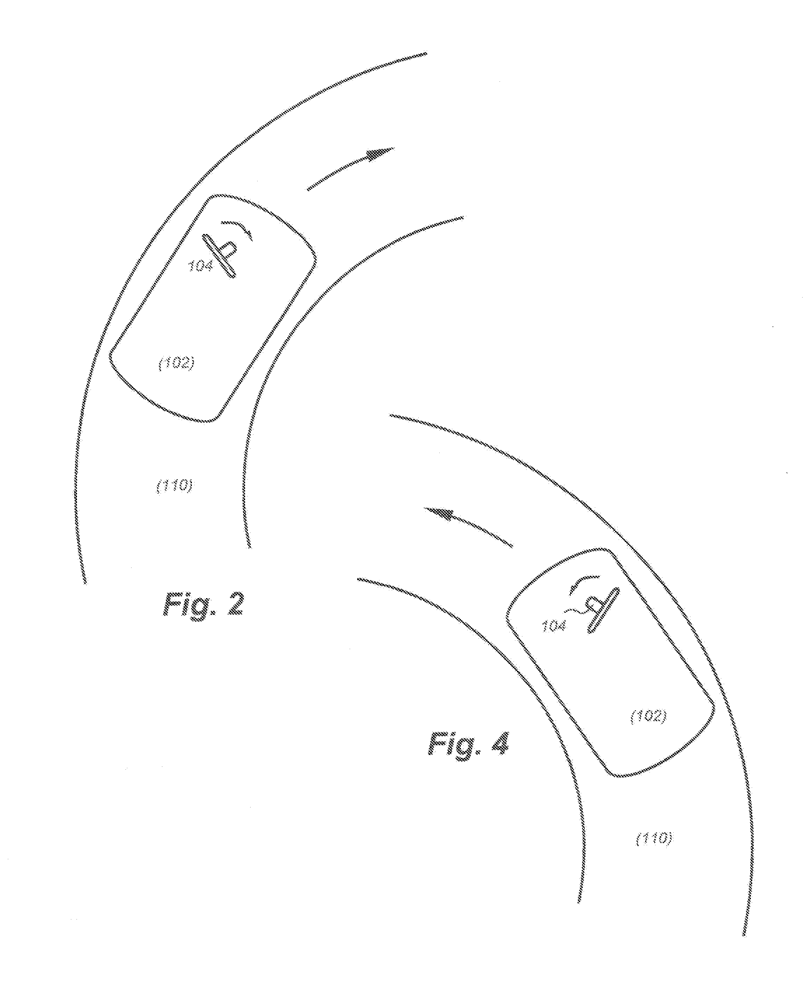

In FIG. 2, a vehicle is proceeding through a right turn. In accordance with the invention, sensors detect the vehicle's change in rotational angle per unit of time. The sensors interface with a processor which, in turn, controls the vehicle's steering column and/or the steering wheel. In the preferred embodiment, as the vehicle proceeds into the right turn, the steering column will advance toward the driver as shown, and the plane defined by the steering wheel will tilt as a function of the turn. Specifically, the face of the steering wheel's three o'clock position will advance toward the driver, and the wheel's nine o'clock position will move away from the driver by the same amount. Preferably, the angle of tilt is in the range of 5 to 45 degrees, more preferably in the range of 15 to 30 degrees, more or less.

FIG. 4 illustrates an example in a left-turn application. Similar to FIG. 1 but in opposite mechanics, as the vehicle proceeds through the left turn, the steering column advances towards the driver and the nine o'clock position of the steering wheel advances towards the driver and the three o'clock position moves away from the driver. As such, the steering wheel ‘bends’ into the left and advances towards the driver.

As shown in FIGS. 3A, B with respect to a right-hand turn, either the steering column 304 and wheel 302 can pivot (FIG. 3A), or the steering wheel may pivot on the column, as depicted in FIG. 3B.

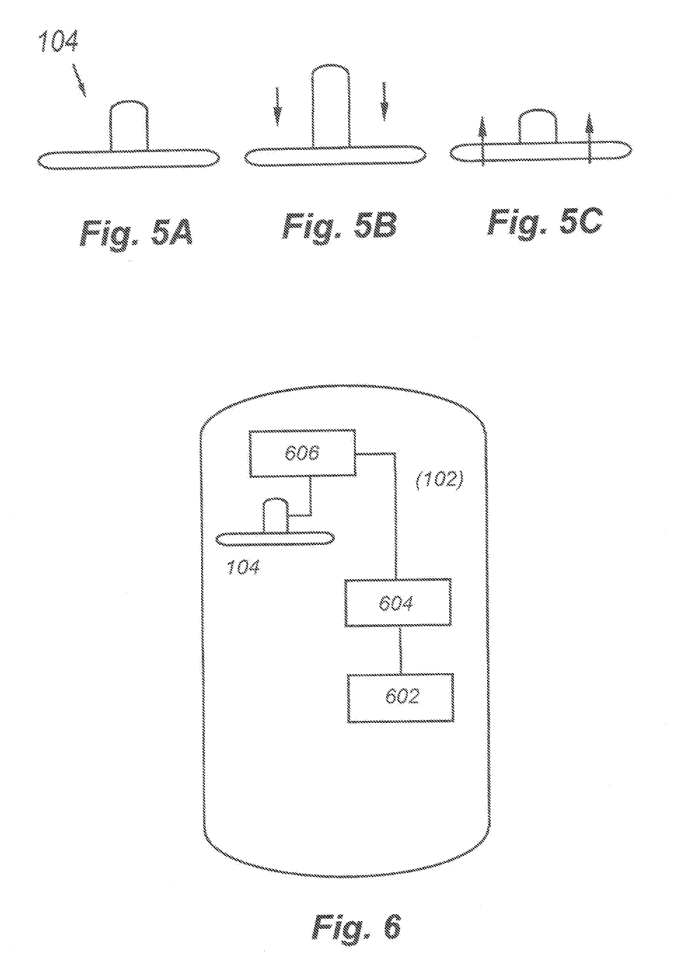

FIGS. 5A-C are examples braking, forced deceleration and acceleration according to the invention. FIG. 5A again shows a steering wheel in a “home” position. Figure SB shows the steering wheel of FIG. 5A being advanced toward a driver in conjunction with an emergent braking situation, and FIG. 5C shows the steering wheel of FIG. 5A being pulled away from a driver in conjunction with a vehicle acceleration;

In a braking situation, whether in a straight path or in a curve, the steering wheel advances towards the driver, providing support to the driver's inertia and decelerating g-forces. In the preferred embodiment, approximately 5 cm of movement takes place towards the driver, though the amount may be varied by more or less depending upon current conditions. For example a range in the amount of 1 to 10 cm is applicable to both the deceleration and acceleration situations of FIGS. 5B, C, respectively.

FIG. 6 is a block diagram illustrating major electronic subsystems associated with the invention. Various types of sensors, or combination of sensors, may be used to detect the change in the vehicle's rotational angle, including gyroscopic sensors, accelerometers, and/or wheel or road sensors. In FIG. 6, one or more sensor modules 602 deliver signals to processor 604, which in turn operates drive block to move the steering column and/or steering wheel. In the preferred embodiment, based upon the sensor input(s), the processor is able to determine the vehicle's instantaneous pitch, speed, roll and braking to automatically adjust the steering column and wheel in the manner just described.

Such sensor positioning is flexible, and additional vehicle sensors may be placed in the proximity of the steering system, or at the wheels, to detect pitch, roll, speed and send that information accordance with other sensor signals to processor 604 and the vehicle steering system 606.

Processor block 604 may represent an isolated microcontroller, or the like, though more preferable the system integrates with a vehicle's electronic control unit (ECU). Likewise, control block 606 my represent any appropriate mechanical system capable of providing the requisite movements, including motors, stepper motors, pistons, cylinders, and other form of linear actuators, whether electrical or hydraulic. It the preferred embodiments, the steering system is a “fly-by-wire” arrangement enabling more straightforward implementation of the invention due to the mechanical decoupling of the steering system to the wheels.

In accordance with the invention, the steering system can be set to different modes of operation, including Standard, which mimics traditional steering systems; Part Time, which is Steering column movement only; and Full Time, which is full multi-plane movement. Such modes of operation would be selected from buttons on the dashboard or, more preferably, through touch points on a screen display used for navigation, for example.

### Airbag and Safety Considerations

To optimize the efficiency, safety and performance of the steering system, a Roller Grip Steering Wheel 902, housed with two parallel dual stage, angle-adjusted inflation airbags 910, 912 may be offered as shown in FIG. 10. The Roller Grip Steering Wheel will roll on the steering wheel housing concurrent with maximum angle movement forward and backward. The grips 904, 906 will not roll freely on wheel, however, and will accommodate a centrally located airbag 908. As the wheel adjusts forward and backward in left and right turns, this feature reduces sliding in the drivers hands and offers a more interactive personal driving experience.

The address safety concerns about the airbags deploying at an angle upon the driver in a collision, the airbags will inflate at different rates (Dual-Stage) depending on the angle of wheel. If the wheel is adjusted where the nine o'clock is closest to the driver, then the three o'clock-side airbag will deploy faster followed by the nine o'clock. Similarly, if the three o'clock side of the steering wheel is closest to the driver in a collision, the nine o'clock version will adjust and inflate faster.

As a back-up safety feature, in addition to the angle sensitive airbag deployment, the vehicle may be equipped with a SNAP BACK feature. This will function concurrently with the airbag deployment system. Simply put, the SNAP BACK feature will instantaneously restore the steering wheel and column to the home position, regardless of what position they are in, as the airbags are being deployed.

### Seating Configurations

In accordance with further embodiments, the seating may be programmed to move in synchronization with the angle and movement of the steering wheel as described with reference to FIGS. 7-9.

FIG. 7 shows a neutral straight driving position with head rest, seatback 702 and integrated roller cushion base 704, some or all of which may be synchronized with steering system movements. The lower portion of the seat assembly is received by the curved cushion base 704 with stand-off rollers 706, enabling the seat to rock from side-to-side in accordance with signals from sensors 602. A drive mechanism 710, which again may be based upon rotary or linear actuation, causes seat movement in response to changes in g-force. While not shown actuator(s) may be provided for front-to-back movements as well.

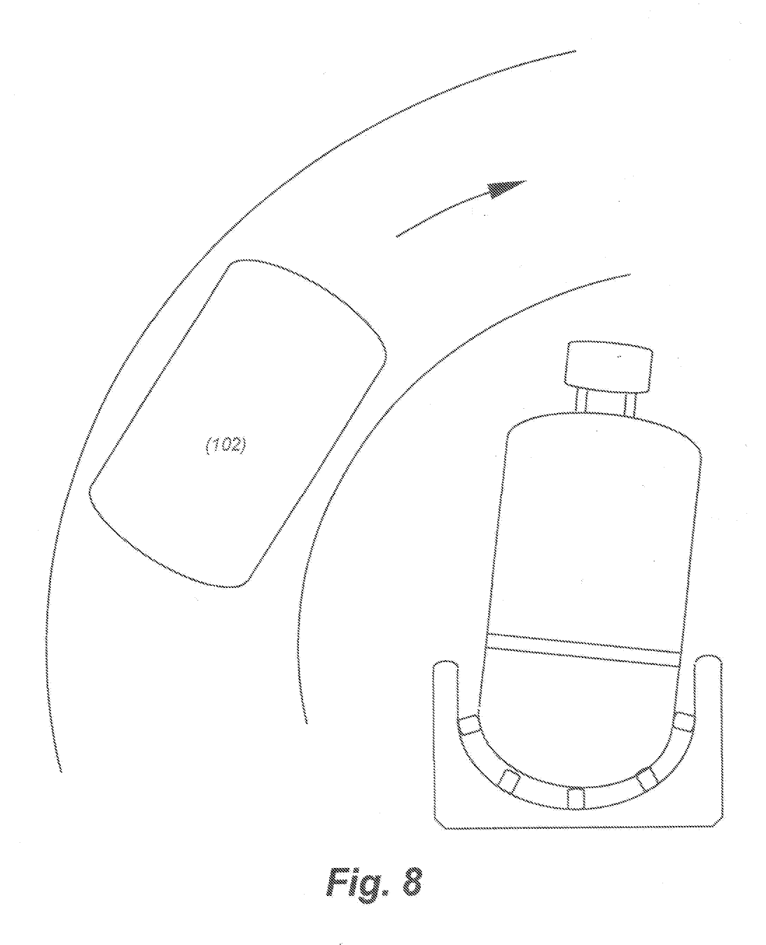

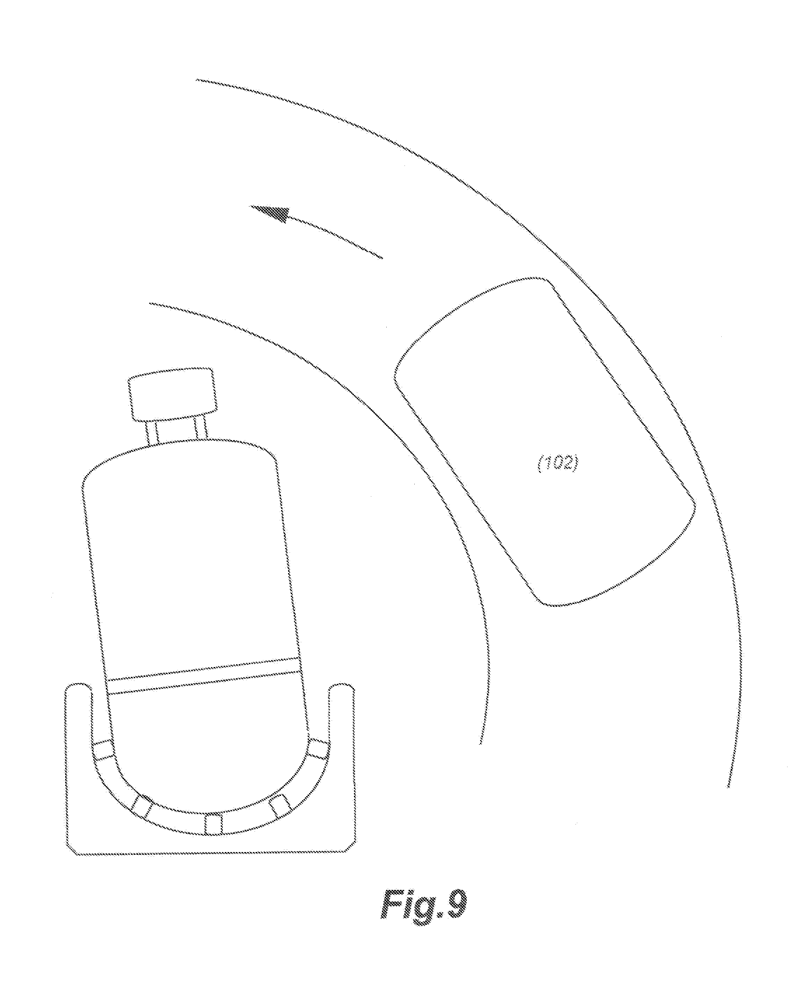

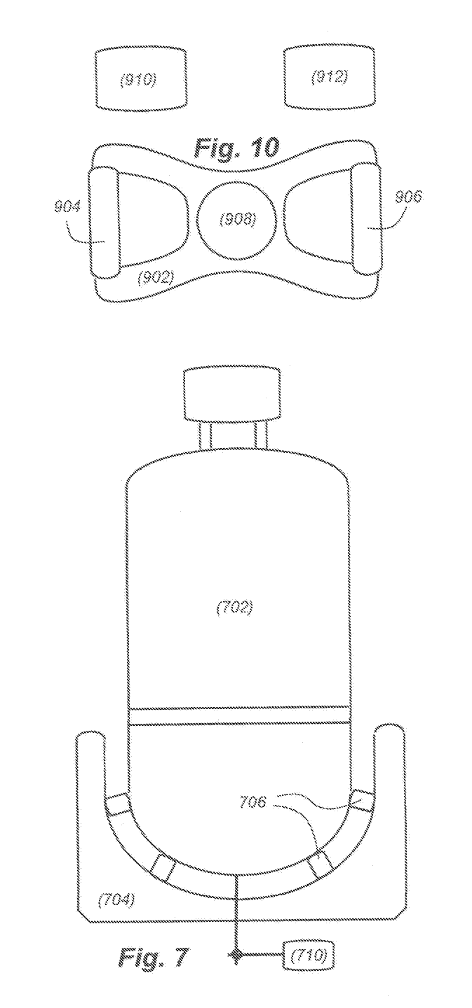

For example, in FIG. 8, as the vehicle 102 makes a right turn, the seat automatically adjusts its base angle to compensate for gravitational forces, vehicle pitch, lean and roll. The base has motorized rollers that swivel with direction from the vehicles onboard computer and steering system, controlled by a process receiving inputs from the gyroscopic sensors and/or other vehicle sensors. In FIG. 9, the seat adjusts this time to the left when making a left turn. Note that the seat may be adjusted independently of the steering wheel/column and in an alternative embodiment, the seat and steering wheel/column may be rigidly connected to one another as part of a seat pod,

In summary, this invention enhances the performance, safety and engineering of a vehicle through intuitive connections to a driver's actions. The system and method provide added comfort with steering synchronized seating arrangements. The enhancements strengthen the ‘emotional bond’ between the driver and the vehicle, while potentially providing relief from driver fatigue.

1. A curve and terrain responsive steering system adapted for use with a vehicle having a steering wheel, accelerator, and braking system, comprising:
one or more sensors disposed within the vehicle to measure g-forces;
a processor in the vehicle receiving signals from the one or more sensors, the processor being operative to send control signals to the steering wheel in response to the signals received; and
an electromechanical system operative to physically move the steering wheel relative to a driver of the vehicle in response to the control signals received from the processor.

2. The system of claim 1, wherein:
the one or more sensors are operative to measure the g-force associated with a right or left turn of the vehicle; and
the electromechanical system is operative to tilt the steering wheel in the direction of the turn.

3. The system of claim 1, wherein:
the one or more sensors are operative to measure the g-force associated with a deceleration of the vehicle; and
the electromechanical system is operative to move the steering wheel toward a driver in response to the deceleration.

4. The system of claim 1, wherein:
the one or more sensors are operative to measure the g-force associated with an acceleration of the vehicle; and
the electromechanical system is operative to move the steering wheel away from a driver in response to the acceleration.

5. The system of claim 1, further including:
a pivoting seat within the vehicle; and
electromechanical apparatus within the vehicle causing the seat to tilt from side-to-side in the direction of a turn.

6. The system of claim 1, further including:
a pivoting seat within the vehicle; and
electromechanical apparatus within the vehicle causing the seat to tilt from front-to-back in response to vehicle braking and acceleration.

7. The system of claim 1, wherein the electromechanical apparatus within the vehicle causes a driver's seat to tilt from front-to-back or front-to-back in response to vehicle turning, braking or acceleration.

8. The system of claim 7, wherein the electromechanical apparatus within the vehicle also causes a passenger's seat to tilt from front-to-back or front-to-back in response to vehicle turning, braking or acceleration.

9. The system of claim 1, wherein the steering wheel is attached to a steering column that also physically moves in conjunction with the steering wheel relative to a driver of the vehicle in response to the control signals received from the processor.

10. The system of claim 1, wherein the processor is in communication with, or forms part of, an existing vehicle electronic control unit (ECU).

11. The system of claim 1, wherein the vehicle steering system is a fly-by-wire steering system with no direct mechanical linkage between the steering wheels and vehicle wheels.

12. The system of claim 1, wherein the one or more sensors includes an accelerometer.

13. The system of claim 1, wherein the one or more sensors includes a gyroscope.

14. The system of claim 1, wherein the electromechanical system operative to physically move the steering wheel includes a motor.

15. The system of claim 1, wherein the electromechanical system operative to physically move the steering wheel includes linear actuator.

16. The system of claim 1, wherein the processor is further operative to bring the steering back to a neutral home position for airbag deployment.

17. The system of claim 1, wherein the steering wheel includes rotating side handles.
